(19) United States
(12) Patent Application Publication
(10) Pub. No.: US 2024/0189767 A1
(43) Pub. Date: Jun. 13, 2024

(54) AIR TREATMENT MODULE

(71) Applicant: Direct Carbon AB, Navigatörgatan 10 (SE)

(72) Inventors: Ida Iranmanesh, Nacka (SE); Anders Edström, Hallstahammar (SE)

(21) Appl. No.: 18/286,821

(22) PCT Filed: Apr. 13, 2022
(86) PCT No.: PCT/EP2022/059956

§ 371 Date: Oct. 13, 2023

(30) Foreign Application Priority Data
Apr. 16, 2021 (SE) 2150477-4

(51) Int. Cl. B01D 53/62

(52) U.S. Cl. CPC B01D 53/62; B01D 2257/504; B01D 2258/06; B01D 2259/4009

(57) ABSTRACT

The present inventive concept relates to a module for treating air. The module comprises a rotational filter assembly comprising a filter unit comprising a carbon dioxide capturing media; an inlet connected to the rotational filter assembly, and an outlet connected to the rotational filter assembly, wherein a regenerating region is formed between the inlet and the outlet; a conduit connecting the outlet to the inlet, thus forming a collection loop passing through the rotational filter assembly and the regenerating region; and a first flow generator configured to generate a flow in the collection loop. The module is configured to capture carbon dioxide from a main stream of air when the carbon dioxide capturing media is in a capturing region, and to release captured carbon dioxide to the collection loop when the carbon dioxide capturing media is in the regenerating region. The module further comprises: a second inlet connected to the conduit, the second inlet being configured to provide a regenerating gas to the collection loop for facilitating said release of captured carbon dioxide; and a second outlet connected to the conduit, the second outlet being configured to discharge the released carbon dioxide from the collection loop; wherein the filter unit is configured to rotate between the capturing region and the regenerating region.

### TECHNICAL FIELD

The inventive concept described herein generally relates to the field of air treatment, and in particular to a module for managing carbon dioxide scrubbing.

### BACKGROUND

Today, the field of indoor climate and indoor air quality has numerous aspects relating to comfort and health issues, but also aspects relating to energy efficiency and efficiency in general, relating to e.g. lifespan of filters. In the context of this application, controlling the indoor climate refers to aspects of climate such as temperature, humidity and pollution.

To control the indoor air pollution levels, the indoor air is commonly filtered and recirculated and/or let outside, and ambient or outside air is let inside.

However, filtering the air of pollutants is an energy intensive process, due to the large amounts of air that need to be heated, both for comfort reasons but also for filtering reasons, such as for regenerating filtering systems.

Today, climate awareness is a driving factor in innovation in many technical fields. There is a large interest among countries, companies and individuals to live a life with as small a carbon footprint as possible. The need to optimize air treatment systems, for e.g. commercial, industrial and residential buildings, is still great, especially regarding handling of the filtered pollution. A common solution is to either let out pollutants, e.g. carbon dioxide, to the outdoor air, or collect it in a filter, which is later replaced and discarded. Replacing filters may be a cumbersome and expensive process. Furthermore, letting out pollutants to the outdoor air is a poor solution to this problem.

There are examples of air treatment systems trying to be more energy efficient, e.g. regenerating filtering systems. These systems may use heat and/or chemicals to regenerate a filter, thus increasing its life length. These systems still have efficiency problems and offer no good solution to the handling of the pollution.

In order to alleviate some of these drawbacks, solutions have been proposed to increase the efficiency of the energy usage and of the handling of the pollution. For example, heat exchangers can be used to transfer energy between indoor and outdoor air. This may reduce the need for heating and/or cooling. Also, measuring the indoor pollution levels, such as carbon dioxide levels, can lead to a reduction in the ventilation need and thus the energy requirements. There are also examples of different ways the filters can be replaced for more efficient operating of an air treatment system.

However, there is still a need for more efficient air treatment systems that can provide a good solution for the handling of the pollution, while still providing energy efficient scrubbing of e.g. carbon dioxide.

Thus, it is of interest to develop efficient systems for treating indoor air, systems which provide efficient energy usage, efficient capturing of pollution, such as carbon dioxide, and effective ways to handle filtered pollution.

### SUMMARY OF THE INVENTION

It is an object of the present inventive concept to mitigate, alleviate or eliminate one or more of the above-identified deficiencies in the art and disadvantages singly or in combination.

According to a first aspect of the inventive concept, these and other objects are achieved in full, or at least in part, by a module for treating air. The module comprising: a rotational filter assembly comprising a filter unit comprising a carbon dioxide capturing media; an inlet connected to the rotational filter assembly, and an outlet connected to the rotational filter assembly, wherein a regenerating region is formed between the inlet and the outlet; a conduit connecting the outlet to the inlet, thus forming a collection loop passing through the rotational filter assembly and the regenerating region; and a first flow generator configured to generate a flow in the collection loop. The module is configured to capture carbon dioxide from a main stream of air when the carbon dioxide capturing media is in a capturing region, thus treating the main stream of air, and to release captured carbon dioxide to the collection loop when the carbon dioxide capturing media is in the regenerating region. The module further comprises: a second inlet connected to the conduit, the second inlet being configured to provide a regenerating gas to the collection loop for facilitating said release of captured carbon dioxide; and a second outlet connected to the conduit, the second outlet being configured to discharge the released carbon dioxide from the collection loop. The filter unit is configured to rotate between the capturing region and the regenerating region.

In general, the present inventive concept is based on the idea of an air treatment module scrubbing a main stream of air comprising contaminants and/or impurities and/or pollution in an efficient manner and taking care of the carbon dioxide that is scrubbed from the air. More specifically, the idea of the present inventive concept is based on the idea of concentrating carbon dioxide in a collection loop in a continuous manner, while filtering air from a main stream of air.

It will be appreciated that the module may provide energy efficient scrubbing of the air while collecting carbon dioxide in a closed loop, allowing non-clean air from a locale, e.g. an office space, to be scrubbed of carbon dioxide. The carbon dioxide is concentrated in the closed loop over time, and may be discharged. It will be further appreciated that the module may be configured to only collect carbon dioxide, thus avoiding collecting a gas with unspecific composition.

It will further be appreciated that the module may store carbon dioxide temporarily. More specifically, carbon dioxide may be stored temporarily in a closed loop. For example, if the amount of carbon dioxide released from the carbon dioxide capturing media to the collection loop is relatively low, then carbon dioxide may be stored a relatively long time inside the closed collection loop until a decision to discharge the matter inside the collection loop is made.

The present inventive concept is further advantageous in that it provides simple, yet efficient, concentration of carbon dioxide, via a closed loop, until a desired concentration of carbon dioxide has been reached. The volume in the closed loop having the desired concentration of carbon dioxide may then be transported to a container for storage or to an external location for use. The external location may be a second locale in the essentially same building as the first locale from which the main stream of air originates. For example, the discharged carbon dioxide may be transported to the second locale, which may be a greenhouse.

The present inventive concept is advantageous in that the module may work in most air treatment systems as a stand-alone module. The module works well as a stand-alone module e.g. because it has relatively few requirements for operation, is small in size and is very adaptable.

The present inventive concept is further advantageous in that it can reuse already heated air in the collection loop for regenerating the rotational filter assembly, making it more energy efficient.

The module comprises a rotational filter assembly, wherein the rotational filter assembly comprises a filter unit comprising a carbon dioxide capturing media. The carbon dioxide capturing media may comprise one or more filters, of the same or different types. The carbon dioxide capturing media may be an adsorbent which captures carbon dioxide by adsorption, e.g. an adsorption filter. The carbon dioxide capturing media may comprise a granulate filter. The carbon dioxide capturing media may comprise a powder filter. The module may further comprise other filters, such as a HEPA filter unit, a PM filter unit and/or a biological filter unit for removing biological contaminants. The biological filter unit may comprise UV sterilization and/or filter material. The rotational filter assembly may be substantially circular. The filter unit may be substantially circular.

The module further comprises an inlet connected to the rotational filter assembly, and an outlet connected to the rotational filter assembly, wherein a regenerating region is formed between the inlet and the outlet, inside the rotational filter assembly.

The module further comprises a conduit connecting the outlet to the inlet, thus forming a collection loop passing through the rotational filter assembly and the regenerating region. The conduit allows air to circulate in a closed loop. The collection loop may be seen as the combination of components which allows air to circulate in a loop.

The regenerating region is the part of the rotational filter assembly through which air in the collection loop may pass through. In other words, air from the collection loop may be introduced into the regenerating region via the first inlet, pass through the filter unit comprising the carbon dioxide capturing media and be released to the collection loop via the outlet.

The rotational filter assembly comprises at least a capturing region, and is the part of the rotational filter assembly through which air from the main stream of air can pass through, and where the air from the main stream may be scrubbed of at least carbon dioxide by the carbon dioxide capturing media.

The regenerating region and the capturing region may be two circle sectors of the rotational filter assembly, in the case where the rotational filter assembly is substantially circular. The circle sector corresponding to the capturing region may constitute a larger part of the rotational filter assembly than the circle sector corresponding to the regenerating region. The regenerating region and the capturing region may be substantially or at least partially separated regions inside the rotational filter assembly. The regenerating region and the capturing region may be substantially or at least partially separated by e.g. one or more divider walls.

The module further comprises a first flow generator configured to generate a flow in the collection loop. The first flow generator may be a fan. However, it is to be understood that the first flow generator may be any device configured to generate a flow.

Furthermore, the module is configured to capture carbon dioxide from a main stream of air when the carbon dioxide capturing media is in the capturing region, thus treating the main stream of air by filtering/scrubbing. The main stream of air may be a flow of air of 400-500 m³/hour. The main stream of air may comprise carbon dioxide at a concentration of 200-1000 ppm. The main stream of air may comprise 0,5 to 80% carbon dioxide. Further, the module is configured to release captured carbon dioxide to the collection loop when the carbon dioxide capturing media is in the regenerating region. It will be appreciated that the module of the present inventive concept allows the capturing of carbon dioxide by the carbon dioxide capturing media in the capturing region, at the same time as carbon dioxide is released into the collection loop from the capturing media in the regenerating region. When the carbon dioxide capturing media is in the regenerating region, carbon dioxide will be released to the collection loop. Over time, the concentration of carbon dioxide in the collection loop will increase. Since the air in the collection loop passes through the carbon dioxide capturing media continuously, releasing more carbon dioxide for each passing, in a closed loop, the carbon dioxide concentration increases.

The module further comprises a second inlet connected to the conduit. The second inlet is configured to provide a regenerating gas to the collection loop, for facilitating a release of captured carbon dioxide, from the carbon dioxide capturing media. The regenerating gas may be outdoor air. The regenerating gas may be indoor air, which may be advantageous when the outdoor air is colder than the indoor air, because the release of carbon dioxide from the carbon dioxide capturing media may be increased at a higher temperature. Using indoor air as a regenerating gas may thus decrease the energy required to bring the regenerating gas to a desired temperature as compared to using outdoor air. The influx of regenerating gas during operation may preferably be 5-25%, more preferably 5-15%, more preferably 8-12% and most preferably 10% of the influx of air in the main stream of air. For example, the main stream of air may have a flow rate of 500 m³/hour, and the influx of regenerating gas via the second inlet may be 50 m³/hour. The preferred ratios between the flow rate of the main flow of air and the flow rate of the regenerating gas via the second inlet may provide an improved energy efficiency. Furthermore, it may make the concentrating of carbon dioxide in the module more efficient. The regenerating gas may be introduced into the conduit intermittently, which may further improve the efficiency of the carbon dioxide concentration, and may improve the energy efficiency of the module. Since then regenerating gas may be introduced into the collection loop only when considered necessary, e.g. for efficient operation. It will be appreciated that the second inlet may provide regenerating gas to the collection loop during filtering and regeneration.

The module further comprises a second outlet connected to the conduit. The second outlet is configured to discharge the released carbon dioxide from the collection loop. It is to be understood that the discharge may discharge all the fluids present in the collection loop, such as oxygen, hydrogen etc., not only carbon dioxide. The discharge may be performed intermittently. It will be appreciated that the discharge through the second outlet can be performed during filtering and regeneration. It will be further appreciated that the module may be used together with a compressor and a container to store the carbon dioxide discharged by the second outlet. For example, the gas discharged from the second outlet may be compressed by a compressor, and be stored or transported to a desired location.

Furthermore, the filter unit is configured to rotate between the capturing region and the regenerating region. The filter unit may rotate in relation to the rotational filter assembly. For example, the filter unit may rotate around an axis in the center of the rotational filter assembly. It is to be understood that any further filter unit in the rotational filter assembly may or may not rotate around said axis in the rotational filter assembly. The rotation of the filter unit provides continuous filtering and continuous regeneration. During operation, the filter unit may rotate at a constant speed, and/or the rotational speed may be adjusted to suit a present or predetermined need. The speed at which the filter rotates affects the amount of carbon dioxide that is released to the collection loop and eventually discharged from the collection loop. It will be appreciated that the filtering and the regeneration can be performed simultaneously. It will be further appreciated that the filtering, the regeneration and the carbon dioxide concentration, as well as the discharging, can be performed simultaneously.

Initially, some terminology may be defined to provide clarification for the following disclosure.

The terms “contaminant”, “impurities” and “pollution” are in the present disclosure defined as, but not limited to, particles, compounds or molecules which have a detrimental effect on human health, and/or which are undesired in a flow of air to be provided as an inflow to e.g. buildings or closed spaces wherein people are present. Hence, elements that may exist naturally in the air, such as carbon dioxide, may be considered pollution. Other examples of air pollutions may include e.g. particulate matter, benzene, nitrogen dioxide, sulphur dioxide, carbon monoxide, benzo(a)pyrene, radon, ozone, and volatile organic compounds (VOC) e.g. including hydrocarbons (HC), formaldehyde, alcohols, etc.

By the term “filter unit” it is here meant, but not limited to, any unit which removes, absorbs, adsorbs, scrubs or filters particles and/or gas. In the present disclosure, the filter unit may be a cassette.

By the term “air”, in particular with regards to air present in the collection loop or flowing into or out of the collection loop, it is to be understood that it may refer to any kind of gas, e.g. regenerating gas, or matter.

According to an embodiment of the present inventive concept, the module further comprises a heater configured to increase and/or maintain a temperature of the gas in the collection loop. The present embodiment is advantageous in that the temperature of the gas in the collection loop may be heated to a temperature which improves the release of carbon dioxide from the carbon dioxide capturing media.

According to an embodiment of the present inventive concept, the gas is regenerating gas and/or released carbon dioxide. It is to be understood that the gas is the gas present in the collection loop at any given time. The gas may comprise only regenerating gas, e.g. when no carbon dioxide is being or have been scrubbed. The gas may comprise only carbon dioxide, or at least to the extent that the gas is saturated with carbon dioxide. The present embodiment is advantageous in that the gas comprises gases that are not as toxic as other pollutions, and may be discharged through the second outlet to a locale where people can reside, e.g. a greenhouse.

According to an embodiment of the present inventive concept, the temperature is between 38° C.-80° C. It is to be understood that the temperature may refer to the temperature of the gas in the collection loop. It may especially refer to the temperature of the gas entering the rotational filter assembly via the first inlet, and is used to facilitate the reaction in the carbon dioxide capturing media. The temperature of the gas in the collection loop may be in the interval 38° C. to 200° C. The gas in the collection loop may maintain a temperature of 38° C. to 120° C. Preferably the gas should maintain a temperature of at least 38° C., to allow the carbon dioxide capturing media to release carbon dioxide. The present embodiment is advantageous in that the temperature interval, 38° C.-80° C., is optimal for improving the release of carbon dioxide from the carbon dioxide capturing media in the regenerating region, to the collection loop. Furthermore, it is advantageous in that it is energy efficient. Furthermore, the present embodiment is advantageous because the heat is easier to control in the collection loop, i.e. there is required less means to control the heat.

According to an embodiment of the present inventive concept, the module is configured to capture carbon dioxide from a main stream of air having a carbon dioxide concentration of <300 ppm. The carbon dioxide concentration of the main stream may more preferably be <250 ppm, even more preferably <200 ppm and most preferably <100 ppm. The present embodiment is advantageous in that the module is able to capture carbon dioxide at low concentrations of carbon dioxide. This is further advantageous in that the module may collect and concentrate carbon dioxide in the collection loop from a main stream of air with a relatively low concentration of carbon dioxide.

According to an embodiment of the present inventive concept, the main stream of air comprises air from at least one of outdoor air and indoor air. The present embodiment is further advantageous in that the module is more versatile, and thus suited for more air treatment systems.

According to an embodiment of the present inventive concept, the filter unit comprises an upstream side and a downstream side in the regenerating region. The first flow generator may be arranged at the downstream side of the filter unit. In particular, the upstream side and the downstream side may be defined with respect to a direction of flow of gas in the collection loop. In the present disclosure, when the first flow generator is arranged at the downstream side of the filter unit, in the closed loop, the first flow generator is essentially closer to the downstream side of the filter unit than the upstream side of the filter unit. This is advantageous in that the first flow generator pulls carbon dioxide from the carbon dioxide capturing media in the filter unit. In other words, it improves the carbon dioxide release, or desorption in the case of the carbon dioxide capturing media comprising an adsorbent. The increased pull is caused by the first flow generator creating a region of lower pressure on the downstream side of the filter unit comprising the carbon dioxide capturing media.

According to an embodiment of the present inventive concept, the first flow generator is arranged such that air is pulled through the filter unit in the regenerating region. The present embodiment is advantageous in that the release of carbon dioxide from the carbon dioxide capturing media is improved.

According to an embodiment of the present inventive concept, the module further comprises a third inlet connected to the capturing region of the rotational filter assembly, the third inlet being configured to direct the main stream of air to the capturing region. It is envisioned that the module may further comprise a third outlet, through which air that passes through the capturing region may exit. In other words, the main stream of air may enter the capturing region via the third inlet, pass through the capturing region, then exit the capturing region via a third outlet.

According to an embodiment of the present inventive concept, the module further comprises a second flow generator in fluid communication with the third inlet and configured to generate a flow via the third inlet towards the capturing region. The present embodiment is advantageous in that the capturing of carbon dioxide from the main stream of air is improved.

According to an embodiment of the present inventive concept, the filter unit comprises an upstream side and a downstream side in the capturing region. The second flow generator may be arranged at the upstream side of the filter unit. This is advantageous in that the flow generator pushes carbon dioxide into the carbon dioxide capturing media in the filter unit, thus improving carbon dioxide capture. The increased push is caused by the flow generator creating a region of higher pressure on the upstream side of the filter unit comprising the carbon dioxide capturing media.

According to an embodiment of the present inventive concept, the second inlet and the second outlet comprise respective closing arrangements, allowing the collection loop to be closed to form a closed collection loop, and to be opened to discharge gas from the collection loop. This is advantageous in that it allows all the regenerating gas to be re-used in the collection loop. This provides increased energy efficiency since new air does not need to be heated for increased efficiency of the release of carbon dioxide from the carbon dioxide capturing media. This is further advantageous in that the concentration of carbon dioxide in the collection loop may become higher, allowing the module to discharge carbon dioxide less often and/or discharge higher amounts of carbon dioxide with each discharge. The closing arrangements may comprise at least one valve, such as a one-way valve. The closing arrangement at the second inlet may allow regenerating gas to flow into the collection loop via the second inlet, and it may be done without letting air from the collection loop slip out via the second inlet. The closing arrangement at the second outlet may allow air in the collection loop to be discharged via the second outlet, and it may be done without letting any air in to the collection loop via the second outlet.

According to an embodiment of the present inventive concept, the module is further configured to receive a control signal to cause the second inlet and the second outlet to assume a closed configuration until at least one predetermined condition has been fulfilled. In the present embodiment, the closing arrangements may open in response to a control signal. The second inlet and the second outlet may open when the predetermined condition has been met, thus allowing carbon dioxide to be discharged from the collection loop, and regenerating gas to be introduced into the collection loop. The closing arrangement of the second inlet and the closing arrangement of the second outlet may be open the same amount of time, to e.g. substantially maintain the gas pressure inside the collection loop.

The amount of regenerating gas to be introduced may correlate to the amount of gas that is discharged from the collection loop, to e.g. allow a substantially constant gas pressure to be upheld in the collection loop. For example, when the collection loop reaches a certain carbon dioxide concentration, a control signal may be received by the module to signal an opening of the closing arrangements at the second inlet and the second outlet. The closing arrangements at the second outlet and the second inlet may both open or close in response to a control signal. The second inlet and the second outlet may open individually, i.e. the closing arrangement at the second inlet, or the second outlet, may open while the other closing arrangement is closed, to allow e.g. adjustment of the pressure inside the collection loop. The control signal may be received from an external entity, such as a cloud-based application or a monitoring device. The control signal may also be received from an internal processing unit, i.e. processing circuitry, connected to the module. The module may comprise the internal processing unit. The module may send the control signal to the closing arrangements. The present embodiment is advantageous in that the amount of carbon dioxide in the collection loop may be at least partially controlled. Hence, the amount of carbon dioxide to be discharged may be at least partially controlled. It is to be understood that the second inlet and second outlet may open independently of each other. For example, the second inlet may let regenerating gas in simultaneously, before, or after the opening of the second outlet.

According to an embodiment of the present inventive concept, the at least one predetermined condition is at least one of: a concentration of carbon dioxide within the collection loop reaching a predetermined threshold, and a time elapsed since a previous discharge of gas in the collection loop. The present embodiment is advantageous in that the module may discharge air from the collection loop with a known concentration of carbon dioxide. This allows for more precise use of the carbon dioxide. It is to be understood that the time elapsed may directly correlate to the amount of carbon dioxide in the collection loop. The time elapsed may be enough to determine the carbon dioxide concentration substantially accurate, if the module has been calibrated beforehand.

According to an embodiment of the present inventive concept, the time elapsed is based on at least one of the turn rate of the rotational filter, the type of filter, a thickness of the filter, a flow rate in the collection loop defined as the flow rate created by the flow generator in the collection loop, a flow rate of the main stream of air, the area of the regenerating region and a desired carbon dioxide concentration in the air discharged by the second outlet. The present embodiment is advantageous in that the module may better control the amount of carbon dioxide that is discharged by the second outlet. For example, the flow rate in the collection loop may have an effect on the release of carbon dioxide from the carbon dioxide capturing media to the collection loop. The flow rate of the main stream of air, from which carbon dioxide is absorbed, may have an effect on the amount of carbon dioxide released to the collection loop. The area of the regenerating region may further have an effect on the concentration of carbon dioxide in the collection loop, specifically by affecting the amount of carbon dioxide released by the carbon dioxide capturing media.

It will be appreciated that when one or more of the flow rate in the collection loop, the flow rate of the main stream of air, and the area of the regenerating region is determined, the time required to reach a desired concentration of carbon dioxide in the collection loop can be more accurately determined. Hence, the elapsed time between discharges of gas from the collection loop may be more accurately determined.

According to an embodiment of the present inventive concept, the module further comprises a sensor configured to determine the concentration of carbon dioxide in the collection loop. The present embodiment allows for a more precise and secure way of determining the concentration of carbon dioxide in the collection loop. Hence, control of the carbon dioxide concentration in the discharge from the collection loop may be more accurate.

A feature described in relation to one aspect may also be incorporated in other aspects, and the advantage of the feature is applicable to all aspects in which it is incorporated.

A feature described in relation to one embodiment may also be incorporated in other embodiments, and the advantage of the feature is applicable to all embodiments in which it is incorporated. Unless explicitly stated otherwise, any combination of embodiments disclosed herein are possible.

Other objectives, features and advantages of the present inventive concept will appear from the following detailed disclosure, from the attached claims as well as from the drawings.

Generally, all terms used in the claims are to be interpreted according to their ordinary meaning in the technical field, unless explicitly defined otherwise herein. Further, the use of terms “first”, “second”, and “third”, and the like, herein do not denote any order, quantity, or importance, but rather are used to distinguish one element from another. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present inventive concept, will be better understood through the following illustrative and non-limiting detailed description of the present inventive concept, with reference to the appended drawings, wherein:

FIG. 1 schematically illustrates a module according to the inventive concept;

FIG. 2a schematically illustrates a rotational filter assembly according to the inventive concept.

FIG. 2b schematically illustrates a cross-sectional side view of the module according to the inventive concept.

FIG. 3a-c schematically illustrate the module according to the inventive concept.

FIG. 4 schematically illustrates the module according to the inventive concept.

FIG. 5a-c schematically illustrates a closing arrangement according to the inventive concept.

The figures are not necessarily to scale, and generally only show parts that are necessary in order to elucidate the inventive concept, wherein other parts may be omitted or merely suggested.

### DETAILED DESCRIPTION

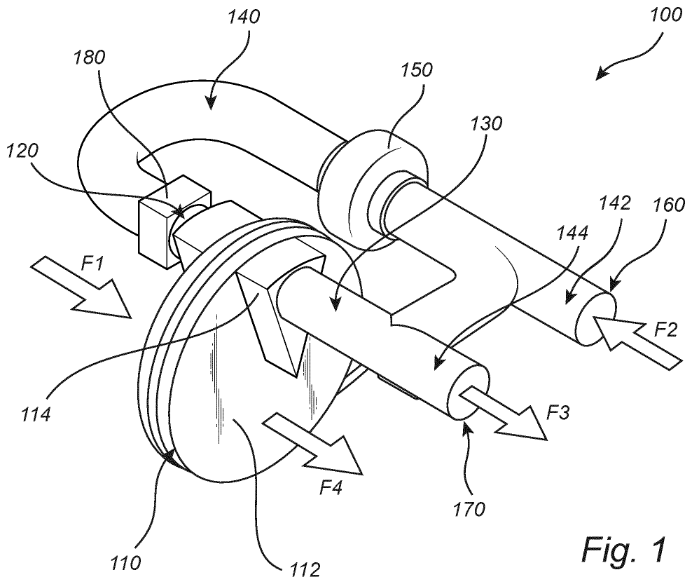

FIG. 1 illustrates a module for treating air according to the inventive concept. The module 100 here comprises a rotational filter assembly 110 comprising a filter unit (not shown) arranged inside the rotational filter assembly 110, wherein the filter unit comprises a carbon dioxide capturing media. The filter unit may e.g. be a cassette. The module 100 further comprises an inlet 120 connected to the rotational filter assembly 110, and an outlet 130 connected to the rotational filter assembly 110. The module 100 here further comprises a conduit 140 which connects the outlet 130 to the inlet 120, thus forming a collection loop. The collection loop passes through the rotational filter assembly 110 via the inlet 120 and the outlet 130. A regenerating region 114 is formed between the inlet 120 and the outlet 130. The collection loop provides a flow path in which air can circulate through the outlet 130, the conduit 140, the inlet 120 and the regenerating region 114. The collection loop here essentially constitutes a closed loop.

The module 100 further comprises a first flow generator 150 configured to generate a flow in the collection loop. The rotational filter assembly 110 comprises at least two different regions, a capturing region 112 and a regenerating region 114. The module 100 is configured to capture carbon dioxide from a main stream of air, F1, when the carbon dioxide capturing media is in the capturing region, thus treating the main stream of air. In other words, the main stream of air, F1, may enter the capturing region 112, have at least part of its carbon dioxide content absorbed by the carbon dioxide capturing media of the filter unit, then exit the capturing region 112 with less carbon dioxide than before it entered the rotational filter assembly 110, illustrated by flow F4. The main stream of air may be defined as a flow F1 as it enters the capturing region 112 of the rotational filter assembly 110, and may be defined as a flow F4 as it exits the capturing region 112.

The module 100 is further configured to release carbon dioxide to the collection loop when the carbon dioxide capturing media is in the regenerating region 114. The filter unit (not seen) is configured to rotate inside the rotational filter assembly 110, thus moving the carbon dioxide capturing media between the capturing region 112 and the regeneration region 114.

The module 100 further comprises a second inlet 160 and a second outlet 170. The second inlet 160 is connected to the conduit 140 and is configured to provide a regenerating gas to the collection loop for facilitating the release of captured carbon dioxide. The regenerating gas may comprise outdoor air and may be introduced to the second inlet 160 via a flow F2. The regenerating gas may comprise recirculated indoor air from the flow F4. The second outlet 170 is connected to the conduit 140 and is configured to discharge the carbon dioxide which has been accumulating over time in the collection loop after being released from the carbon dioxide capturing media in the regenerating region 114.

The second inlet 160 and the second outlet 170 may comprise respective closing arrangements 142, 144. The closing arrangements 142, 144 allow the collection loop to be selectively closed and opened to control discharge and intake of gas from and to the collection loop. In particular, the closing arrangement 142 may assume an open configuration, thus allowing regenerating gas to enter the collection loop via the second inlet 160. Furthermore, the closing arrangement 142 may assume a closed configuration, thus preventing regenerating gas from entering the collection loop via the second inlet 160. Likewise, the closing arrangement 144 may assume an open configuration, thus allowing regenerating gas and/or carbon dioxide within the collection loop to be discharged from the collection loop via the second outlet 170. Furthermore, the closing arrangement 144 may assume a closed configuration, thus preventing regenerating gas and/or carbon dioxide within the collection loop to be discharged from the collection loop via the second outlet 170. The closing arrangement 142 may assume an opened configuration, thus allowing regenerating gas to enter the collection loop via the second inlet 160.

The second outlet 170 may be closed until a predetermined condition has been fulfilled, and further the second outlet 170 may be opened once the predetermined condition is fulfilled to discharge the carbon dioxide, i.e. the gas inside the collection loop comprising carbon dioxide, from the collection loop. The gas inside the collection loop may comprise a relatively high concentration of carbon dioxide, up to 100%. Thus, the gas being discharged from the collection loop, through the second outlet 170, may comprise a relatively high concentration of carbon dioxide. However, it is to be understood that the amount of carbon dioxide which is discharged may also be relatively low. In particular, in some cases, gas without any released carbon dioxide may be discharged from the collection loop.

The amount of carbon dioxide released may be controlled by the predetermined condition. For example, the predetermined condition may be a concentration of carbon dioxide within the collection loop reaching a predetermined threshold and/or a time elapsed since the previous discharge of gas in the collection loop. By determining the carbon concentration in the collection loop via a sensor, it is possible to determine when the predetermined condition has been fulfilled, and hence to determine when to discharge gas from the collection loop. The sensor may be arranged in the collection loop, e.g. the conduit 140. The time elapsed since a previous discharge may affect the amount of carbon dioxide in the collection loop. In particular, if one or more of the turn rate of the filter unit, a flow rate in the collection loop defined as the flow rate created by the first flow generator 150 in the collection loop, a flow rate of the main stream of air and the area of the regenerating region 114, is known, a determination of the carbon dioxide concentration in the collection loop may be made in combination with the time elapsed since the previous discharge.

The module 100 here further comprises a heater 180. Preferably, the heater 180 is arranged near the inlet 130. The heater 180 is configured to increase and/or maintain the temperature of the gas in the collection loop. It is advantageous to arrange the heater 180 in the collection loop in close proximity to the regenerating region 114, to facilitate maintaining a constant temperature in the regenerating region 114, since it both provides more energy efficient heating and improved desorption.

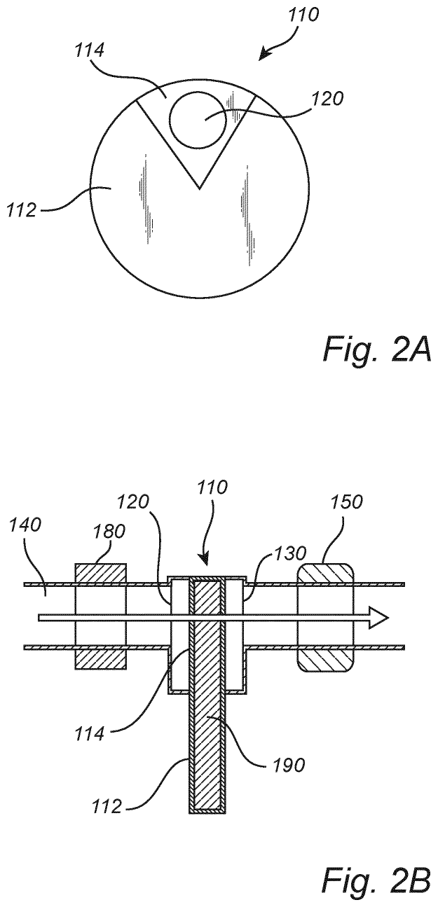

Referring now to FIG. 2a, a front view of a rotational assembly 110 is shown. The rotational assembly 110 here comprises a first inlet 120. The rotational assembly 110 here further comprises a capturing region 112 and a regenerating region 114. The regenerating region 114 is formed between the inlet 120 and the outlet (not shown). The rotational filter assembly 110 here further comprises a filter unit (not shown). The filter unit rotates between the capturing region 112 and the regenerating region 114. In FIG. 2a, the filter unit rotates around an axis extending through the center of the rotational filter assembly 110. The rotational speed of the filter unit may affect the amount of carbon dioxide which is captured from the main stream of air, and hence the rotational speed may also affect the concentration of carbon dioxide in the collection loop and/or a timing of opening and closing the closing arrangements 142,144 to allow gas to enter and be discharged from the collection loop.

In FIG. 2a, a circle sector corresponding to the capturing region constitutes a larger part of the rotational filter assembly than a circle sector corresponding to the regenerating region. The relative size of the circle sector of the capturing region 112 in relation to size of the circle sector of the regenerating region 114 may be decided by a plurality of factors, such as the desired carbon concentration, the efficiency of the filtering/scrubbing and the content/flow of the main stream of air. The circle sector corresponding to the regenerating region 114 may be larger than the circle sector corresponding to the capturing region 112. It is to be understood that capturing region 112 and the regenerating region 114 may have other shapes than a circle sector.

Referring now to FIG. 2b, a cross-sectional side view of the module 100 is shown. In FIG. 2b, the module 100 comprises a rotational filter assembly 110, an inlet 120 and an outlet 130. The rotational filter assembly 110 here further comprises a capturing region 112, and a regenerating region 114 formed between the inlet 120 and the outlet 130. The rotational filter assembly 110 further comprises a filter unit 190. The filter unit 190 here rotates around an axis which is parallel with the direction of the flow, the direction of the flow being indicated by the arrow, passing through the regenerating region 114.

The module 100 in FIG. 2b further comprises a conduit 140, connecting the outlet 130 and the inlet 120. The module 100 further comprises a first flow generator 150, and a heater 180. The first flow generator 150 is here arranged on the downstream side of the regenerating region 114 close to the outlet 130. Advantages and effects of such a placement of the first flow generator 150 have been described in the Summary section of the present disclosure, and will for the sake of brevity not be repeated here. The heater 180 is here arranged on the upstream side of the regenerating region 114, near the inlet 120. This placement of the heater 180 may improve heating of gas going into the regenerating region 114 through the inlet 120, thus improving or facilitating the release of the carbon dioxide from the carbon dioxide capturing media. The filter unit 190 may comprise a substantially circular shape. The filter unit 190 may have a first part in the capturing region 112 at all times, and a second part of the filter unit in the regenerating region 112 at all times. Thus, the module 100 may simultaneously capture carbon dioxide by the carbon dioxide capturing media in the capturing region 112, and release carbon dioxide from the carbon dioxide capturing media to the collection loop in the regenerating region 114, in a continuous manner.

It is to be understood that the rotational filter assembly 110 may comprise a plurality of capturing regions 112 and a plurality of regenerating regions 114, through which the filter unit passes upon rotation in the rotational filter assembly. Furthermore, it is to be understood that the module 100 may comprise more than one collection loop. In other words, there may be two regenerating regions 114, each one connected to its own collection loop having one or more features and being arranged as described in the present disclosure. A module comprising a plurality of collection loops may provide for collection of gas within several collection loops, each collection loop having a different concentration of carbon dioxide. Such carbon dioxide concentration may be controlled by e.g. the flow rate within each collection loop, an area of the regenerating region connected to each collection loop, and/or closing and opening of the respective inlets and outlets allowing regenerating gas to enter the collection loop and gas to be discharged from the collection loop respectively.

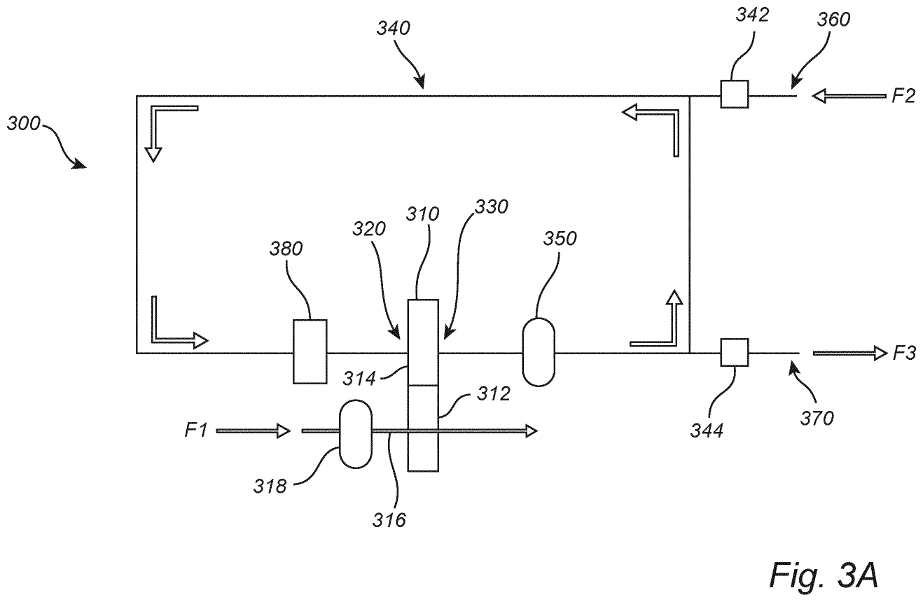

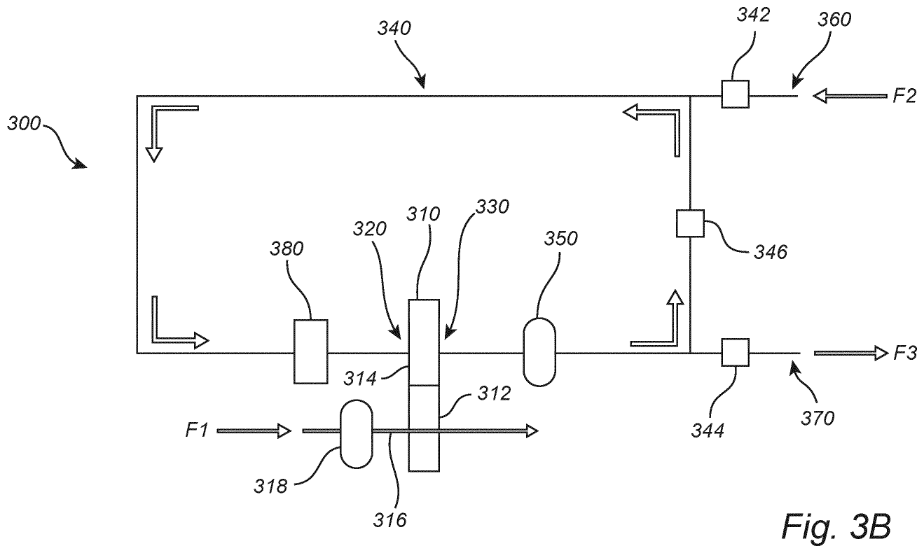

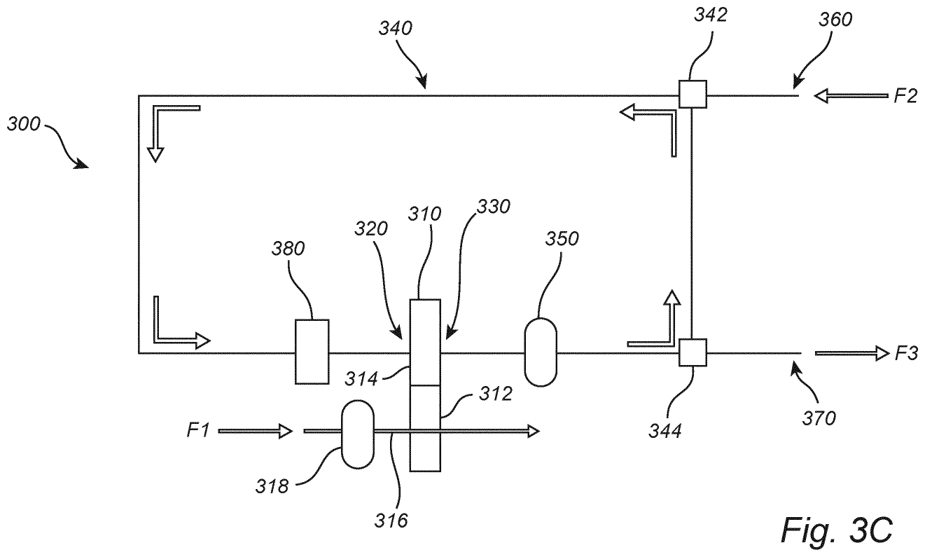

FIG. 3A schematically illustrates a module 300 according to the inventive concept. The module 300 here comprises a rotational filter assembly 310, an inlet 320 and an outlet 330. The regenerating region 314 may be formed between the inlet 320 and the outlet 330. The module 300 further comprises a conduit 340, a second inlet 360 connected to the conduit 340 and a second outlet 370 connected to the conduit 340. The module 300 further comprises closing arrangements 342, 344 for the second inlet 360 and the second outlet 370 respectively. The closing arrangements 342, 344 allow the collection loop to form a closed loop, while said closing arrangements 342, 344 are in a closed configuration, and further allow intake of regenerating gas to the collection loop while at least said closing arrangement 342 is in an opened configuration. The second inlet 360 allows regenerating gas to be introduced to the collection loop. The corresponding closing arrangement 342 allows the introduction of regenerating gas to be controlled. The closing arrangements 342, 344 may be any kind of damper, shutter, throttle or one-way valve, that control an air flow in a passage, e.g. the second inlet 360, the second outlet 370 and the conduit 340. The intake of regenerating gas via the second inlet 360 and flow F2, and the discharge of gas from the collection loop via the second outlet 360 and the flow F3, may be performed intermittently and repeatedly, respectively. The discharge of gas via the second outlet 370 from the collection loop may be performed at predetermined intervals and/or based on the current concentration of carbon dioxide in the collection loop.

The module 300 in FIG. 3A further comprises a first flow generator 350, arranged on the downstream side of the rotational filter assembly 310, significantly closer to the outlet 330 than the inlet 320. The module 300 here further comprises a heater 380 arranged on the upstream side of the rotational filter assembly 310, significantly closer to the inlet 320 than the outlet 330.

In FIG. 3A the module 300 further comprises a third inlet 316. The third inlet 316 is connected to the capturing region 312 of the rotational filter assembly 310 and is configured to direct the main stream of air, F1, to the capturing region 312. The module 300 here further comprises a second flow generator 318. The second flow generator 318 is in fluid communication with the third inlet 316 and is configured to generate a flow via the third inlet 316 towards the capturing region 312.

FIG. 3b schematically illustrates a module 300 which is similar to the module 300 in FIG. 3a. Because much of the configuration and operation of the module 300 is substantially similar to that described in FIG. 3a, a detailed description of features common to the embodiment illustrated in FIG. 3a has been omitted to avoid needless prolixity and for the sake of brevity and conciseness.

In FIG. 3b, the module 300 further comprises a closing arrangement 346. The closing arrangement 346 is arranged in the conduit 340, between the intersection of the conduit 340 and the second inlet 360, and the intersection of the conduit 340 and the second outlet 370. The closing arrangement 346 is configured to stop the air flow between the intersection of the conduit 340 and the second inlet 360, and the intersection of the conduit 340 and the second outlet 370. The closing arrangement 346 may provide a more controlled and improved discharge of air via the second outlet 370. This is because, if the closing arrangement 346 is not present, some of the air circulating in the collection loop may enter the conduit 340 instead of being discharged via the second outlet 370, at the intersection of the conduit 340 and the second outlet 370, even if the closing arrangement 344 is open. Accordingly, the closing arrangement 346 may provide a better control of discharge of air from the collection loop, and/or a better control of the amount of carbon dioxide in the air that is discharged via the second outlet 370. In FIG. 3b, the closing arrangements 342, 344, 346 may comprise dampers, which allows them to be fully opened, fully closed or anywhere in between, i.e. partially open/closed. In FIG. 3b, the closing arrangements 342 and 346 may be controlled in response to the same control signal. Closing arrangements 342 and 346 may have an inverse relationship, such that when one opens, the other closes. The closing arrangements 342, 344, 346 may be configured to be controlled with respect to each other, in order to maintain a desired flow in the collection loop, and a desired carbon dioxide concentration in the discharged air. In other words, the closing arrangements 342, 344 and 346 may work together to maintain a certain flow in the collection, a certain influx via the second inlet, and a certain outflow via the second outlet. Furthermore, the closing arrangements 343, 344 and 346 may open and close independently of each other to any degree, i.e. anywhere in between fully opened and fully closed.

FIG. 3c schematically illustrated a module 300 which is similar to the module 300 in FIG. 3a. Because much of the configuration and operation of the module 300 is substantially similar to that described in FIG. 3a, a detailed description of features common to the embodiment illustrated in FIG. 3a has been omitted to avoid needless prolixity and for the sake of brevity and conciseness.

In FIG. 3c, the closing arrangement 342 is arranged at the intersection of the conduit 340 and the second inlet 360, and the closing arrangement 344 is arranged at the intersection of the conduit 340 and the second outlet 370. In FIG. 3c, the closing arrangements 342, 344 may be configured to assume an open configuration, a closed configuration, or any configuration between, i.e. different grades of semi-opened or semi-closed configurations. The open configuration of closing arrangement 342 allows regenerating gas to enter the collection loop via the second inlet 360, and blocks air from circulating in the collection loop by preventing passage of air, flowing from the closing arrangement 344, through the closing arrangement 342. The closed configuration of the closing arrangement 342 blocks regenerating gas from entering the collection loop via the second inlet 360, but allows air to circulate in the collection loop by allowing passage of air, flowing from the closing arrangement 344, through the closing arrangement 342. The semi-open, or semi-closed, configuration of the closing arrangement 342 allows regenerating gas to enter the collection loop via the second inlet 360, and allows air to circulate in the collection loop.

Similarly, the open configuration of closing arrangement 344 allows air to be discharged from the collection loop via the second outlet 370, and blocks air from circulating in the collection loop by preventing passage of air from the closing arrangement 344 towards the closing arrangement 342. The closed configuration of the closing arrangement 344 blocks air from being discharged from the collection loop via the second outlet 370, but allows air to circulate in the collection loop by allowing passage of air from the closing arrangement 344 towards the closing arrangement 342. The semi-open, or semi-closed, configuration allows air to be discharged from the collection loop via the second outlet 370, and allows air to circulate in the collection loop.

Accordingly, when the closing arrangements 342, 344 are both in a closed configuration, the collection loop essentially forms a sealed loop where regenerating gas may not enter the collection loop via the second inlet 360 and air in the collection loop may not be discharged via the second outlet 370. In such a state, air may circulate in the collection loop. Further, if the closing arrangements 342, 344 are both in an open configuration, air may be discharged from the collection loop via the second outlet 370, and regenerating gas may enter the collection loop via the second inlet 360, but air may not circulate in the collection loop. It is to be understood that all combinations of the open/closed/semi-open/semi-closed configurations of the closing arrangements 342, 344 are possible,

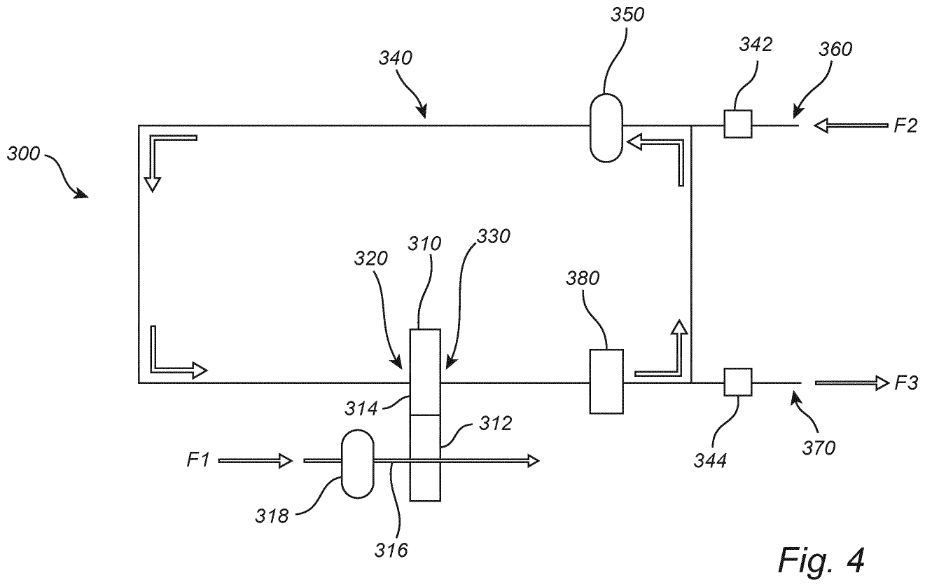

FIG. 4 schematically illustrates a module 300 which is similar to the module 300 in FIG. 3a. Because much of the configuration and operation of the module 300 is substantially similar to that described in FIG. 3a, a detailed description of features common to the embodiment illustrated in FIG. 3a has been omitted to avoid needless prolixity and for the sake of brevity and conciseness.

In FIG. 4, the first flow generator 350 is arranged downstream of the second inlet 360, close to the second inlet 360. This arrangement of the first flow generator 350 may provide an improved influx of regenerating gas into the collection loop. Furthermore, in FIG. 4, the heater 380 is arranged upstream of the second outlet 370, between the rotational filter assembly 310 and the second outlet 370, but closer to the second outlet 370. This arrangement of the heater 380 may improve heating of the gas being discharged to a desired temperature. It is further to be understood that the various arrangements of closing arrangements disclosed in conjunction with FIGS. 3a-c may be applied to the illustrated module.

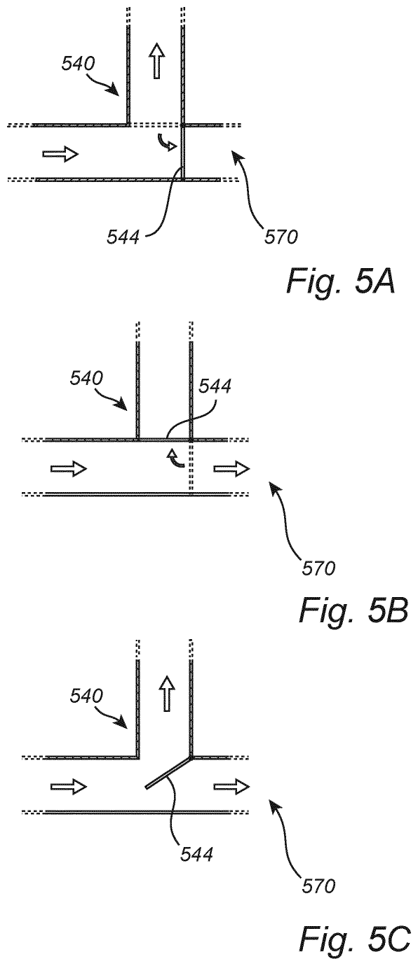

Referring now to FIG. 5a-c, an illustration of a closing arrangement 544 according to the inventive concept is shown. In FIG. 5a-c, the closing arrangement 544 may comprise at least one damper. The closing arrangement may be configured to close an outlet 570, as can be seen in FIG. 5a, close a conduit 540, as can be seen in FIG. 5b, or partially open and close the outlet 570 and the conduit 540, as can be seen in FIG. 5c. The closing arrangement 544 allows the outlet 570 to be closed while the conduit 540 is open, thus forming an essentially sealed collection loop in which carbon dioxide may accumulate. The closing arrangement 544 further allows the outlet 570 to be opened, while preventing flow of air via the passage 540, thus allowing air from the collection loop to be discharged. Furthermore, the closing arrangement 544 allows a part of the air to circulate in the collection loop, and a part of the air to be discharged via the outlet 570.

As is readily appreciated by the person skilled in the art, many modifications and variations may be devised given the above description of the principles of the inventive concept. It is intended that all such modifications and variations be considered as within the scope of the inventive concept, as it is defined in the appended patent claims.

### LIST OF REFERENCE SIGNS

100 Module
110 Rotational filter assembly
112 Capturing region
114 Regenerating region
120 Inlet
130 Outlet
140 Conduit
142 Closing arrangement
144 Closing arrangement
150 First flow generator
160 Second inlet
170 Second outlet
180 Heater
190 Filter unit
300 Module
310 Rotational filter assembly
312 Capturing region
314 Regenerating region
316 Third inlet
318 Second flow generator
320 Inlet
330 Outlet
340 Conduit
342 Closing arrangement
344 Closing arrangement
346 Closing arrangement
350 First flow generator
360 Second inlet
370 Second outlet
380 Heater
390 Filter unit
540 Conduit
544 Closing arrangement
570 Outlet

1. A module (100) for treating air, the module comprising:
a rotational filter assembly (110) comprising a filter unit (190) comprising a carbon dioxide capturing media;
an inlet (120) connected to the rotational filter assembly, and an outlet (130) connected to the rotational filter assembly, wherein a regenerating region (114) is formed between the inlet and the outlet;
a conduit (140) connecting the outlet to the inlet, thus forming a collection loop passing through the rotational filter assembly and the regenerating region; and
a first flow generator (150) configured to generate a flow in the collection loop; wherein the module is configured to capture carbon dioxide from a main stream of air when the carbon dioxide capturing media is in a capturing region, thus treating the main stream of air, and to release captured carbon dioxide to the collection loop when the carbon dioxide capturing media is in the regenerating region;
wherein the module further comprises:
a second inlet (160) connected to the conduit, the second inlet being configured to provide a regenerating gas to the collection loop for facilitating said release of captured carbon dioxide; and
a second outlet (170) connected to the conduit, the second outlet being configured to discharge the released carbon dioxide from the collection loop;
wherein the filter unit is configured to rotate between the capturing region and the regenerating region.

2. The module according to claim 1, further comprising a heater (180) configured to increase and/or maintain a temperature of gas in the collection loop.

3. The module according to claim 2, wherein said gas is the regenerating gas and/or released carbon dioxide.

4. The module according to claim 2, wherein the temperature is between 38° C.-80° C.

5. The module according to claim 1, wherein the module is configured to capture carbon dioxide from a main stream of air having a carbon dioxide concentration of <300 ppm.

6. The module according to claim 1, wherein the main stream of air comprises air from at least one of outdoor air and indoor air.

7. The module according to claim 1, wherein the filter unit comprises an upstream side and a downstream side in the regenerating region, wherein the first flow generator is arranged at the downstream side of the filter unit.

8. The module according to claim 7, wherein the first flow generator is arranged such that air is pulled through the filter unit in the regenerating region.

9. The module according to claim 1, wherein the module further comprises
a third inlet (316) connected to the capturing region of the rotational filter assembly, the third inlet being configured to direct the main stream of air to the capturing region.

10. The module according to claim 9, wherein the module further comprises
a second flow generator (318) in fluid communication with the third inlet and configured to generate a flow via the third inlet towards the capturing region.

11. The module according to claim 10, wherein the filter unit comprises an upstream side and a downstream side in the capturing region, wherein the second flow generator is arranged at the upstream side of the filter unit.

12. The module according to claim 1, wherein the second inlet and the second outlet comprise respective closing arrangements (142, 144), allowing the collection loop to be closed to form a closed collection loop, and to be opened to discharge gas from the collection loop.

13. The module according to claim 12, further configured to receive a control signal to cause the second inlet and the second outlet to assume a closed configuration until at least one predetermined condition has been fulfilled.

14. The module according to claim 13, wherein the at least one predetermined condition is at least one of:
a concentration of carbon dioxide within the collection loop reaching a predetermined threshold, and
a time elapsed since a previous discharge of gas in the collection loop.

15. The module according to claim 14, wherein the time elapsed is based on at least one of the turn rate of the filter unit, the type of filter, a thickness of the filter, a flow rate in the collection loop defined as the flow rate created by the first flow generator in the collection loop, a flow rate of the main stream of air, the area of the regenerating region and a desired carbon dioxide concentration in the air discharged by the second outlet.

16. The module according to claim 14, wherein the module further comprises a sensor configured to determine the concentration of carbon dioxide in the collection loop.
